(19) United States
(12) Patent Application Publication
(10) Pub. No.: US 2019/0199602 A1
(43) Pub. Date: Jun. 27, 2019

(54) METHOD AND APPARATUS FOR CLOSED-LOOP OPTIMIZATION FLOW IN A NETWORK FUNCTIONS VIRTUALIZATION ENVIRONMENT

(71) Applicant: Intel Corporation, Santa Clara, CA (US)

(72) Inventors: Tong ZHANG, Saratoga, CA (US); Zhu ZHOU, Portland, OR (US); Michael A. O'HANLON, Limerick (IE); Atul KWATRA, Gilbert, AZ (US); Brendan RYAN, Limerick (IE)

(21) Appl. No.: 16/290,438

(22) Filed: Mar. 1, 2019

(51) Int. Cl. H04L 12/24; H04L 12/26; G06N 20/00; G06F 9/455; G06F 11/34

(52) U.S. Cl. CPC H04L 41/5009; H04L 41/16; H04L 43/0829; G06F 2009/45595; G06F 9/45558; G06F 11/3409; G06N 20/00

(57) ABSTRACT

Virtual Network Functions (VNF) key performance indicator values can be predicted based on data analytics with an integration of data processing techniques and machine learning algorithms to allow proactive actions to provide Network Functions Virtualization service assurance.

### FIELD

This disclosure relates to networking and in particular to Network Functions Virtualization.

### BACKGROUND

Network Functions Virtualization (NFV) consolidates many network equipment types onto industry standard high volume servers, switches and storage and implements network functions in software that can run on a range of industry standard server hardware, and that can be moved to, or instantiated in, various locations in the network as required, without the need for installation of new equipment.

Network Functions Virtualization allows multiple Virtual Network Functions to share pooled hardware resources that include compute resources, network resources and storage resources. The dynamic nature of management and orchestration of the Virtual Network Functions combined with varying workload can result in degraded services when multiple Virtual Network Functions request use of the shared pooled hardware resources.

To guarantee a Service Level Agreement (SLA), for example, bandwidth and/or latency during peak hours of the day, platform resources are often over-designed which results in lower average utilization and higher than necessary power consumption. Additional resources can be allocated based on time of day schedule or a simple responsive resource re-allocation based on certain monitored system indicators crossing defined thresholds. However, these methods to allocate resources rely on historical profiling and measurements to apply resource scheduling algorithm using pre-defined thresholds and are unable to effectively handle network dynamics or new resource utilization patterns.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a server;

FIG. 2 is a block diagram of a network architecture for the Long Term Evolution (LTE) standard for high-speed wireless communication for mobile devices and data terminals;

FIG. 3 illustrates a data center that includes a plurality of servers as shown in FIG. 1 with at least one of the plurality of servers including the Evolved Packet Core shown in FIG. 2;

FIG. 4 illustrates a method implemented in the system shown in FIG. 3 to identify a subset of key features that correlate to a target Key Performance Indicator Virtual Network Functions (VNF) key;

FIG. 5 is a block diagram of an embodiment of a virtual Cable Modem Termination System (vCMTS) implemented in the server shown in FIG. 1 configured to perform offline training.

FIG. 6 is a block diagram of a machine learning pipeline for closed-loop controller automation;

FIG. 7 is a block diagram of the Long Short Term Memory (LSTM) Recurrent Neural Network shown in FIG. 6 to perform ingress traffic bandwidth forecasting; and

FIG. 8 depicts an example network interface in accordance with some embodiments.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

Mitigation actions to avoid degraded services can be prescribed, if potential performance degradation can be detected. In an embodiment, Virtual Network Functions key performance indicator values can be predicted based on data analytics with an integration of data processing techniques and machine learning algorithms to provide Network Functions Virtualization service assurance.

A machine learning technique is applied to a dynamically forecast varying workload to adaptively adjust the hardware resource configuration to increase efficiency while maintaining required Service Level Agreement (SLA).

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

A server is a computer or device that can be dedicated to managing network resources. Typically, a server can monitor performance metrics that include key performance indicators to understand the state of server. Performance metrics that can be monitored include Central Processing Unit (CPU) utilization, memory utilization and network throughput.

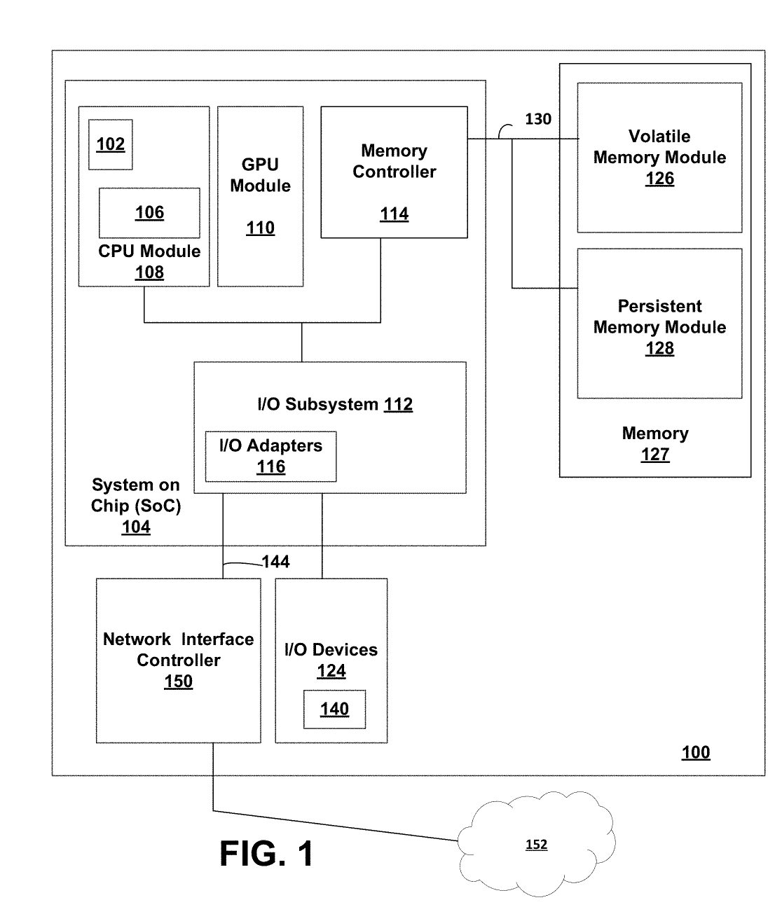

FIG. 1 is a block diagram of an embodiment of a server 100. Server 100 includes a system on chip (SOC or SoC) 104 which combines processor, graphics, memory, and Input/Output (I/O) control logic into one SoC package. I/O adapters 116 may include a Peripheral Component Interconnect Express (PCIe) adapter that is communicatively coupled over bus 144 to a network interface controller 150.

The SoC 104 includes at least one Central Processing Unit (CPU) module 108, a memory controller 114, and a Graphics Processor Unit (GPU) module 110. In other embodiments, the memory controller 114 may be external to the SoC 104. The CPU module 108 includes at least one processor core 102 and a level 2 (L2) cache 106.

Although not shown, the processor core 102 may internally include one or more instruction/data caches (L1 cache), execution units, prefetch buffers, instruction queues, branch address calculation units, instruction decoders, floating point units, retirement units, etc. The CPU module 108 may correspond to a single core or a multi-core general purpose processor, such as those provided by Intel® Corporation, according to one embodiment. In an embodiment the SoC 104 may be a standalone CPU such as an Intel® Xeon® Scalable Processor (SP), an Intel® Xeon® data center (D) SoC, or a smart NIC accelerator card format.

The memory controller 114 may be coupled to a memory 127 that can include a persistent memory module 128 having at least one persistent memory integrated circuit and/or a volatile memory module 126 having at least one volatile memory integrated circuit via a memory bus 130. A non-volatile memory (NVM) device (integrated circuit) is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Volatile memory is memory whose state (and therefore the data stored in it) is indeterminate if power is interrupted to the device. Dynamic volatile memory requires refreshing the data stored in the device to maintain state. One example of dynamic volatile memory (device or integrated circuit) includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

The Graphics Processor Unit (GPU) module 110 may include one or more GPU cores and a GPU cache which may store graphics related data for the GPU core. The GPU core may internally include one or more execution units and one or more instruction and data caches. Additionally, the Graphics Processor Unit (GPU) module 110 may contain other graphics logic units that are not shown in FIG. 1, such as one or more vertex processing units, rasterization units, media processing units, and codecs.

Within the I/O subsystem 112, one or more I/O adapter(s) 116 are present to translate a host communication protocol utilized within the processor core(s) 102 to a protocol compatible with particular I/O devices. Some of the protocols that I/O adapter(s) 116 may be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 116 may communicate with external I/O devices 124 which may include, for example, user interface device(s) including a display and/or a touch-screen display 140, printer, keypad, keyboard, communication logic, wired and/or wireless, storage device(s) including hard disk drives (“HDD”), solid-state drives (“SSD”) 118, removable storage media, Digital Video Disk (DVD) drive, Compact Disk (CD) drive, Redundant Array of Independent Disks (RAID), tape drive or other storage device. The storage devices may be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)).

Additionally, there may be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

It is envisioned that aspects of the embodiments herein can be implemented in various types of computing and networking equipment, such as switches, routers and blade servers such as those employed in a data center and/or server farm environment. Typically, the servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities can typically employ large data centers with a multitude of servers.

Each blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board. These components can include the components discussed earlier in conjunction with FIG. 1.

Telemetry is a process by which measurements and other data are collected and transmitted over a media such as a computer network, wireless communications network or wired communications network for monitoring. The server 100 shown in FIG. 1 can provide telemetry data to provide insight on cache misses, memory utilization, Central Processing Unit (CPU) cycles, and network throughput.

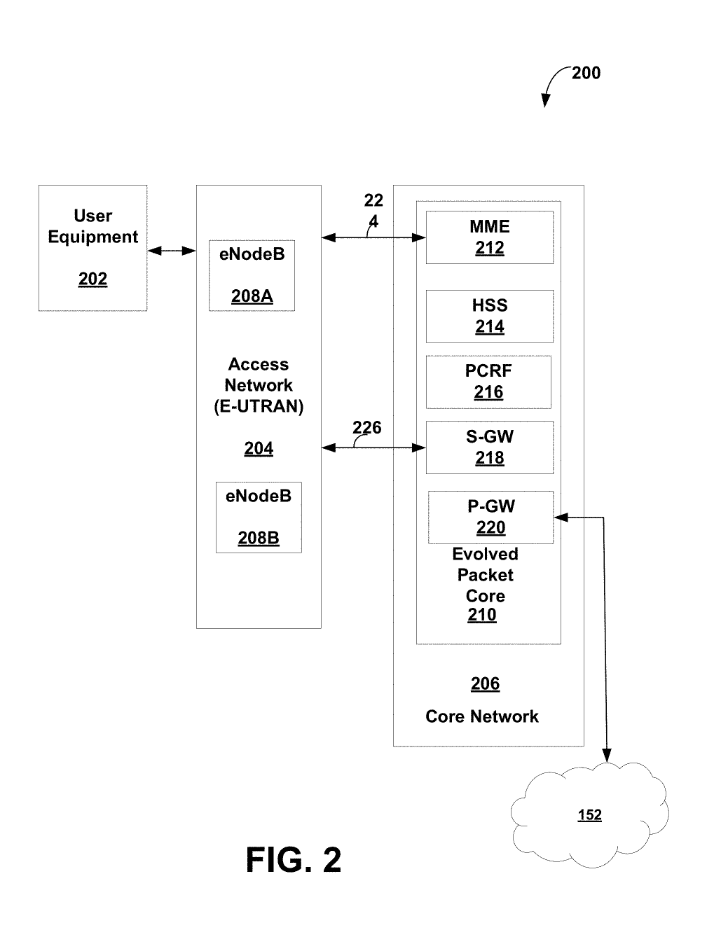

FIG. 2 is a block diagram of a network architecture 200 for the Long Term Evolution (LTE) standard for high-speed wireless communication for mobile devices and data terminals. LTE is also referred to as 3rd Generation Partnership Project (3GPP) Long Term Evolution, LTE Super 3G and LTE Super 4G.

The network architecture 200 for LTE shown in FIG. 2 includes user equipment 202, an access network 204 and a core network 206. The user equipment 202 can be a mobile host or wireless device that communicates wirelessly with an access network 204 that is an Enhanced-Universal Terrestrial Radio Access Network (E-UTRAN). E-UTRAN is the access network for LTE. The E-UTRAN includes base stations (referred to as Evolved Node B (eNodeB) 208A, 208B that connect the user equipment 202 to the network (public network or Internet) 152 via the core network 206.

The core network 206, commonly referred to as 3G (for 3rd Generation Wireless Mobile Communication Technology), can carry many traffic types from real-time Circuit Switched to Internet Protocol (IP) based Packet Switched. The core network 206 includes an Evolved Packet Core (EPC) 210 which is a framework standardized in Release 8 of 3GPP to provide data and converged voice network based on 4G (4^{th} Generation Wireless Mobile Communication Technology) LTE. The Evolved Packet Core 210 is based on an always-on network connection. The Evolved Packet Core 210 includes a Mobility Management Entity (MME) 212, a Packet Data Network Gateway (PDN-GW) 220, a Home Subscriber Server (HSS) 214, a Policy Control and Changing Rules Function (PCRF) 216, and a Serving Gateway (S-GW) 218. The Mobility Management Entity 212 authenticates and tracks users in the network and manages session states. The Serving Gateway 218 routes data packets across the network 152. The Packet Data Node Gateway 220 manages quality of service and performs deep packet inspection. The Policy Control and Changing Rules Function 216 performs policy enforcement and supports service data flow detection.

The eNodeB 208A, 208B allows connectivity between the user equipment 202 and the EPC Core Network 206. The eNodeB 208A, 208B communicates with the other elements of the system through three interfaces: E-UTRAN Uu (communication interface between user equipment and E-UTRAN), S1 (communication interface between the UTRAN and the core network) and X2 (communication interface between eNodeBs).

The E-UTRAN Uu interface (also referred to as LTE Uu or LTE radio interface) implemented in eNodeB 208 permits data transfer between the ENodeB 208A, 208B and the user equipment 202. The eNodeB 208A, 208B communicates with the core network 206 through the S1 interface. The S1 interface is divided into a control plane and a data plane.

The division of the S1 interface into control plane and data plane allows the eNodeB 208A, 208B to connect with two different entities in the Core Network 206. The eNodeB 208A, 208B communicates with a Mobility Management Entity (MME) 212 responsible for plane control operations through the S1-MME interface 224. The eNodeB 208A, 208B communicates with a Serving Gateway (S-GW) 218 responsible for data plane operations through the S1-U interface 226.

The data plane of the S1-U interface 226 refers to the protocol stack used for user data transfer through the interface (for example, Internet Protocol (IP) packets sent by the user equipment 202 to the access network 204 and evolved Packet Core 210 through the S1-U interface 226). The control plane refers to the protocol stack used to support the functions and procedures needed to manage the interface operations (for example, to configure eNodeB 208A, 208B operations from the evolved Packet Core 210 through the S1-MME interface 224).

An X2 communication interface between eNodeBs 208A, 208B can be used to exchange signaling messages to manage radio resources (for example, to reduce interference) and to manage traffic when user equipment 202 moves from one eNodeB 208A, 208B to another eNodeB 208A, 208B during a handover procedure.

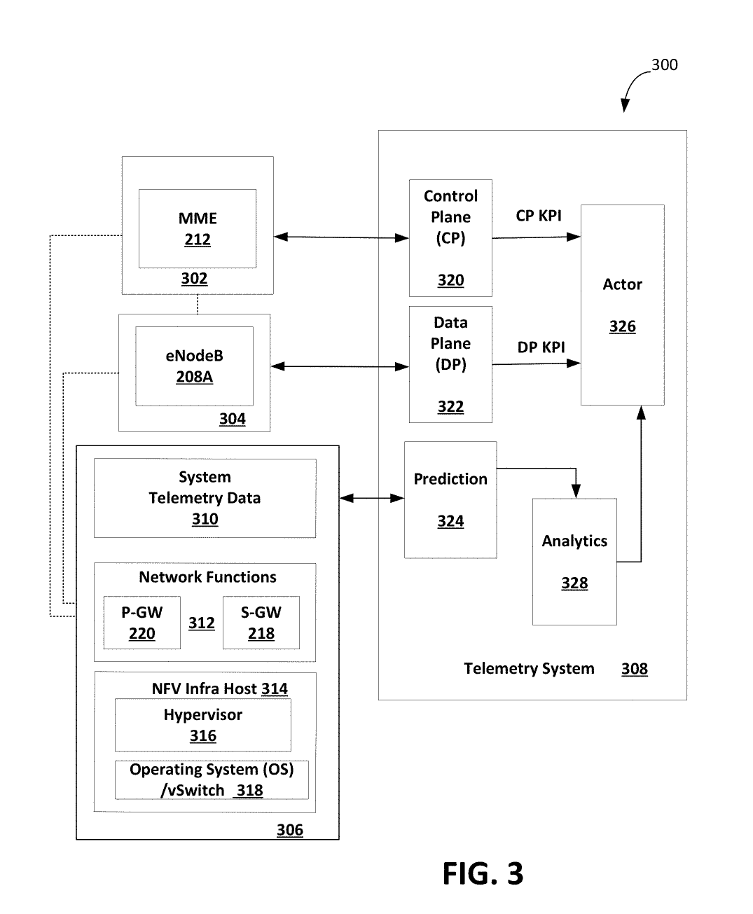

FIG. 3 illustrates a data center 300 that includes a plurality of servers as shown in FIG. 1 with at least one of the plurality of servers including the Evolved Packet Core 210 shown in FIG. 2. In the embodiment shown in FIG. 3, the data center 300 has four servers 302, 304, 306, 308 with three of the servers 302, 304, 306 including Network Virtual Function (NVF) Infrastructure and Network Functions 312 in memory 127. The Network Functions include Service & Packet Data Network GateWay control plane (S-GW) 220 and Service & Packet Data Network GateWay data plane (P-GW) 218.

In an embodiment, the virtual Evolved Packet Core 206 is deployed on a server that includes an Intel® Xeon® Central Processing Unit and system telemetry data 310 is collected in the server using Collectd and stored in memory in the sever as system telemetry data 310. Collectd is an opensource daemon that collects system and application performance metrics periodically and provides mechanisms to store the system telemetry data. The system telemetry data 310 can include: Central Processing Unit (CPU) metrics such as IPC (instructions per cycle), cache misses, TLB (translation look-aside buffer) loads, page fault, branch execution information. The system telemetry data 310 can also include telemetry data related to memory usage, interrupts count, and storage access statistics.

In an embodiment, a subset of the system telemetry data 310 is identified that has a close correlation with a packet loss percentage rate. The packet loss percentage rate can be referred to as a target Virtual Network Functions Key Performance Indicator.

One of the servers, Telemetry System 308 includes telemetry related functions in memory 127. The telemetry related functions include a prediction function 324 to forecast incoming traffic (packets) that can be used for proactive actions to provide Network Functions Virtualization service assurance. Telemetry System 308 also includes an actor function 326 that acts upon the analysis of system and application performance metrics, for example, to modify clock frequency of a processor core 102 or to reallocate cache 106 amongst processor cores 102 in the CPU module 108.

Supervised learning can be used to identify a subset of key features that correlate to a target Key Performance Indicator using training data sets that can be obtained by exercising the virtual Evolved Packet Core with a range of packet inject rates. The corresponding packet loss percentages can be recorded as the actual measured values which can be referred to as “ground truth”.

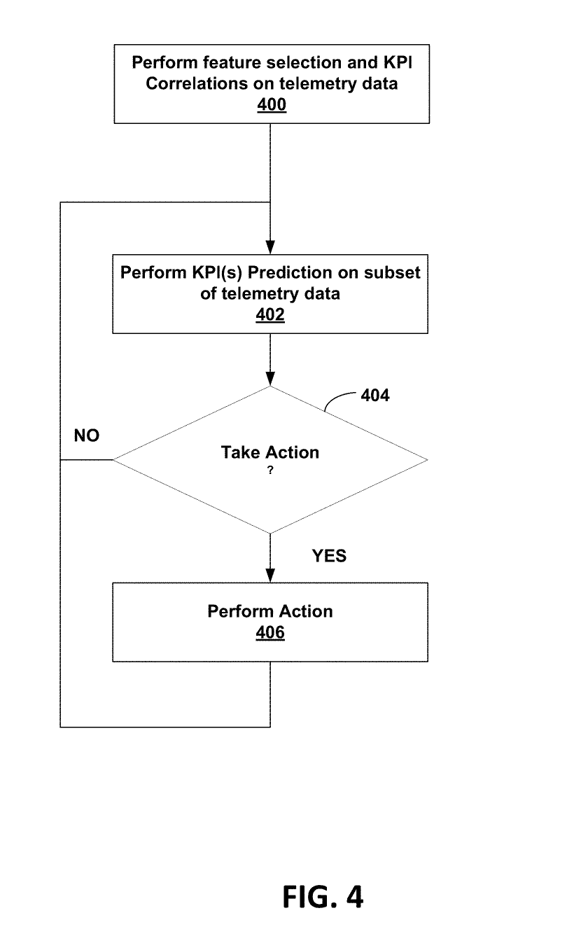

FIG. 4 illustrates a method implemented in the system shown in FIG. 3 to identify a subset of key features that correlate to a target Key Performance Indicator Virtual Network Functions (VNF) key. The subset of key features can be identified based on data analytics with an integration of data processing techniques and machine learning algorithms to predict future key performance indicator values to allow proactive actions to provide Network Functions Virtualization service assurance. FIG. 4 will be described in conjunction with FIG. 3.

At block 400, the control plane (CP) 320 is exercised via Service & Packet Data Network GateWay control plane (S-GW) 218 to establish an internet connection (Internet Protocol (IP) assignment, authentication, etc.) for a configured number of users. This is followed by a packet transmission triggering data plane (DP) 322 processing via Service & Packet Data Network Gateway data plane (P-GW) 220. In a test environment, for the target Key Performance Indicator of packet loss percentage rate, the telemetry data collected during the first phase is irrelevant and filtered out. In a non-test environment, the control plane processing and data plane processing are concurrent processes and collected telemetry data is not filtered out.

The remaining collected telemetry data is timestamp-aligned with one timestamp per second. Linear or polynomial interpolation can be applied for telemetry data (that may also be referred to as “features”) that are sampled. Telemetry data with zero-variance are also removed. The identified telemetry data that is sampled periodically can be referred to as “data samples”. The data samples are normalized and split into training, validation and testing sets. This is a typical machine learning procedure to reserve some data set during the training process so that the algorithm can be validated/tested using data which has not be seen during the training. Typically, the data set is split 8:1:1, that is 80% training, 10% validation and 10% testing. The validation data is used to select model hyperparameters while the test data is used to report results (for example accuracy) of the trained algorithm.

To reduce the amount of telemetry data to be sampled, a representative subset of key telemetry data that has a close correlation with the targeted Virtual Network Functions Key Performance Indicators is identified, so that only the subset of the telemetry data needs to be sampled without affecting the accuracy of detecting/predicting the targeted Key Performance Indicators.

In a multi-core system, some telemetry data are sampled for each core. An “importance” value is assigned to each feature that can be used to select a subset of high impact features. In an embodiment, using the 20 features with the highest “importance value” provides a Mean Squared Error (MSE) of 0.066 in contrast to an MSE of 0.062 using 956 features, that is, a degradation of only 6%. The features with the highest importance value differ dependent on workload and Key Performance Indicator. Features related to virtual Evolved Packet Core include Central Processing Unit (CPU) metrics such as data Translation Lookaside Buffer (dTLB) load misses, instruction Translation Lookaside Buffer (iTLB) loads, page faults, Last Level Cache (LLC) load misses, Level 2 cache requests (for example, L2_RQSTS.ALL_CODE_RD), and Level 1 (L1) data cache (dcache) load misses, branch execution (number of branches from an instruction stream executed on a core (branches)); memory usage such as system memory used (for example, Dynamic Random Access Memory (DRAM)) and cache and memory usage per thread (for example, Intel® Resource Director Technology (Intel® RDT)). Features that have zero standard variance (that is, features with no change) are removed.

In an embodiment, to detect the packet loss percentage (range from 0 to 100), gradient boosting (a regression algorithm) provides the best result in terms of the mean squared error (MSE) metric for the test set. Other embodiments may use other regression algorithms such as support vector machine (SVM) regression, multi-layer perceptron, random forest, and regularized greedy forest. Processing continues with block 402.

At block 402, with the above described telemetry data as input, machine learning classifiers in Analytics 328 in Telemetry System 308 are applied to predict a future trend (for example, if the trend is normal or abnormal) of the target Key Performance Indicator. The Key Performance Indicator of packet loss performance rate is normal if there the predicted future trend is no packet loss and abnormal if the predicted future trend is packet loss.

In one embodiment, a LSTM (Long Short Term Memory) implementation of RNN (Recurrent Neural Network) is applied to the subset of subset of high impact features to predict the packet loss percentage from the selected key telemetry data sampled over a period of time.

In an embodiment, the 20 hardware telemetry data identified in block 400 are sampled every second. Samples of the 20 hardware telemetry data sampled over the previous 60 seconds are input into the LSTM network to predict the packet loss percentage in the next 5 seconds. Processing continues with block 404.

At block 404, based on the predicted packet loss percentage, actions can be taken to avoid service deterioration. For example, the frequency of at least one processor core 102 in the CPU module 108 shown in FIG. 1 can be increased to avoid packet loss or additional cores 102 in the CPU module 108 can be used to process packets when workload is high. If an action is to be taken, processing continues with block 406. If not, processing continues with block 402.

At block 406, the action is taken and processing continues with block 402. An embodiment has been described for a key performance indicator for predicting packet loss rate, in other embodiments other types of virtual network functions (VNFs) and their key performance indicators (KPIs) can be monitored in the system shown in FIG. 3. Other types of virtual network functions (VNFs) can include average latency, maximum latency, jitter, power consumption based on monitoring hardware functions and can include connection failure percentage, or miss-classification error rate based on monitoring software applications executing in the system.

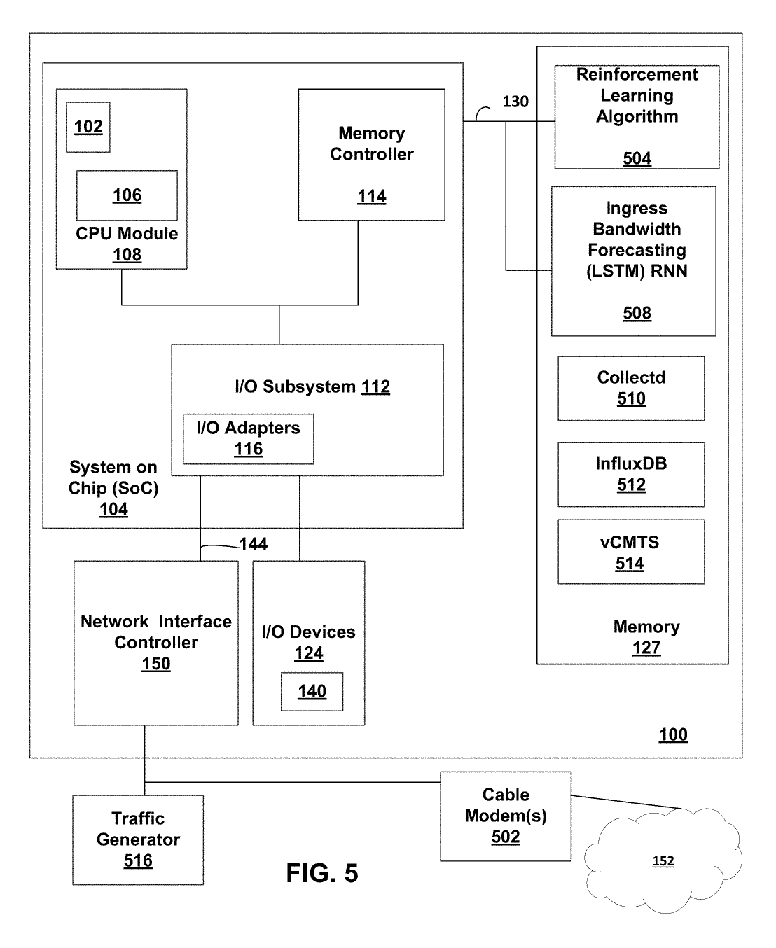

FIG. 5 is a block diagram of an embodiment of a virtual Cable Modem Termination System (vCMTS) 514 implemented in the server 100 shown in FIG. 1 configured to perform offline training. The traditional cable modem termination system (CMTS) appliance that implements Data-over-Cable Service Interface Specification (DOCSIS) MAC and PHY features is split into two main network components: a remote PHY and a virtualized CMTS (vCMTS) 514. The virtualized CMTS 514 reduces total cost ownership by consolidating multiple network functions on off-the-shelf servers.

One server is used as traffic generator 516 capable of simultaneously generating multiple packet streams mimicking upstream/downstream traffic mixes at CMTS systems. Telemetry data (for example, CPU metrics such as, cache misses; memory utilization; CPU cycles and network throughput), incoming traffic and vCMTS specific statistics such as packet scheduling loss are periodically sampled using Collectd 510 at a configurable interval (for example, every second). Collectd 510 forwards the sampled telemetry data into time series data base InfluxDB 512 from where the machine learning modules (Reinforcement Learning Algorithm 504 and Ingress bandwidth forecasting (Long Short Term Memory (LSTM) Recurrent Neural Network (RNN)) 508) can process the sampled telemetry data and issue actions. Following the process described above the machine learning modules learn the optimal core frequency at any system load that meets the service assurance target (no packet loss) while running the lowest possible core frequency to save power.

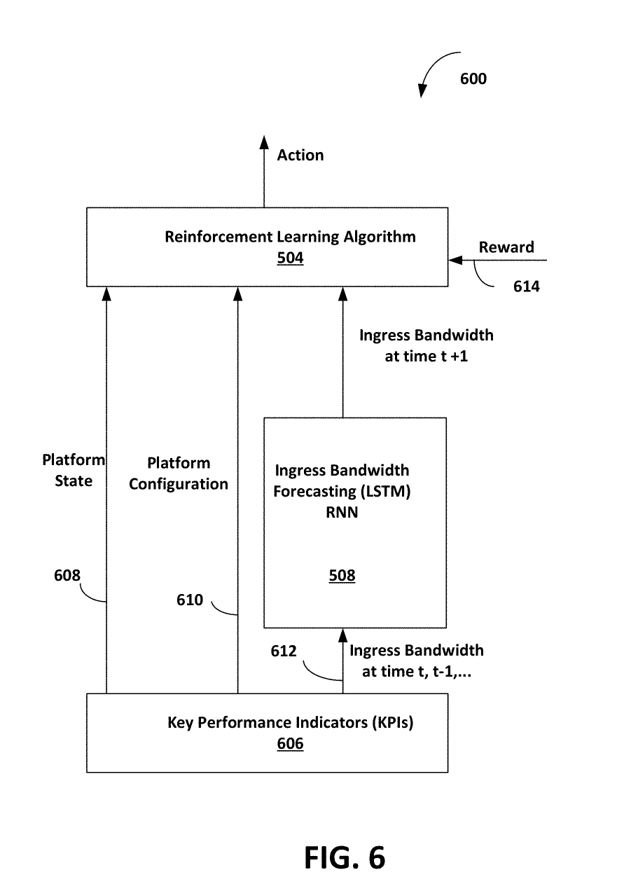

FIG. 6 is a block diagram of a machine learning pipeline 600 for closed-loop controller automation. The machine learning pipeline 600 includes the Reinforcement Learning Algorithm 504, the Long Short Term Memory (LSTM) Recurrent Neural Network 508 and a state of Key Performance Indicators (KPIs) 606.

The training process can be split into three parts. First a LSTM model is trained using historical recorded ingress bandwidth data. Second, the reinforcement learning algorithm 504 is trained offline with simulated state, action and reward temporal sequences. Third, when offline training is completed, the LSTM model is deployed online in a NFV environment and is continuously fine-tuned using the closed-loop controller automation provided by machine learning pipeline 600.

In an embodiment of a system that includes vCMTS 514 as shown in FIG. 5, the reinforcement learning algorithm 504 can adaptively scale clock frequency for the processor core 102 in the CPU module 108 to maximize power saving opportunities during a 24 hour period based on the workload. The reinforcement learning algorithm 504 adaptively learns to map forecasted workload to an optimal and efficient resource allocation to satisfy the required Service Level Agreement (SLA) and outputs an action. The reinforcement learning algorithm 504 can take a proactive action to prevent service degradation based on a future trend (for example, forecasted workload). The action can be to adjust the clock frequency of the processor core 102 or adjust cache allocation in cache 106 in CPU module 108.

The state of key performance indicators (KPIs) 606 is monitored and used to train the reinforcement learning algorithm 504 to adaptively optimize hardware resources (for example, clock frequency for a processor core 102 in the CPU module 108) based on the forecasted workload and current sampled telemetry data. The state of key performance indicators 606 can include a subset of telemetry data representing the platform hardware state 608, platform configuration 610 and ingress bandwidth 612 at time t.

The platform hardware state 608 at time t is represented by identified telemetry data subset. Platform configuration 610 is the platform configuration 610 at time t such as current core frequency fₜ. The ingress bandwidth 612 is the ingress bandwidth measured at time t. b_{c+1} is the forecasted ingress bandwidth at time t+1 using previously observed value b_{c}, bₜ₋₁, . . . .

For the platform hardware set 608, a subset of telemetry data that highly correlate to key performance indicator (KPI) packet loss are selected using the recursive feature elimination (RFE) algorithm from Scikit-Learn machine learning library. Every 10 seconds a core clock frequency between 1 GigaHertz (GHz) and 2.3 GHz is selected and platform telemetry data and packet loss information is sampled every second. The telemetry data includes status such as a count of cache_misses, instructions, and instruction cache load misses (cache_load_misses) and CPU cycle percentage status such as percentage of CPU idle cycles, percentage of CPU system cycles, and percentage of software interrupt requests (soft_irq). Data pre-processing (timestamp alignment, interpolation, missing data handling, normalization, etc.) is performed on the data set, for example, formed as a classification problem with each training sample with 34 features and target label being 0—no packet loss and 1—packet loss.

The RFE algorithm leverages an estimator (for example, (RandomForestClassifier and GradientBoostingClassifier) that assigns weights to features and selects features by recursively keeping smaller and smaller sets of features until a specified number (for example, 8 or 10 top features) is reached. In an embodiment, the top 8 common features selected by the RandomForestClassifier and the GradientBoostingClassifier are related to Central Processing Unit (CPU) metrics. For example, branches ((number of branches executed), branch load misses (code in main memory is not in cache), and branch-loads (code in the cache)); data Translation Lookaside buffer (dTLB store misses (data in main memory is not in cache), dTLB-loads (read from a data translation lookaside buffer) and dTLB stores (write to a data translation lookaside buffer)); and cache hits/misses (L2 RQSTS.CODE_RD_HIT (count of cache hits in L2 cache), L2 RQSTS.CODE_RD_MISS (count of cache misses in L2 cache)). The state of key performance indicators 606 includes the 8 common features listed above representing the platform hardware state 608, current core frequency for the platform configuration 610 and ingress bandwidth 612 forecasted for the next period (for example, next 10 seconds).

The action aₜ is the core frequency to set for next 10 seconds. In an embodiment in which the core frequency range is between 1 GHz and 2.3 GHz and the frequency step is 100 MHz, there are 14 discrete core frequencies (“actions”).

In an embodiment, the Long Short Term Memory (LSTM) Recurrent Neural Network 508 is used to predict workload fluctuation. Workload fluctuation of ingress data (ingress traffic pattern) received by a cable modem is monitored in order to forecast future traffic demand. Ingress data is data originating outside a local network that is transmitted within the local network.

The Long Short Term Memory (LSTM) Recurrent Neural Network 508 is used to selectively memorize the historical patterns during the training process. The previous T samples of ingress packet rate are used to predict workload bandwidth. In addition to past measured bandwidth data samples, relevant past telemetry data can be used for more accurate prediction.

The reinforcement learning algorithm 504 uses a predicted ingress traffic rate and telemetry data such as last level cache and memory allocation for each active core 102, core Instructions Per Cycle (IPC), the Level 1 (L1)/Level 2 (L2) cache hit rate, and other relevant information to decide appropriate control action for optimal resource placement. In an embodiment, the value of the reward signal is dependent on key performance indicators such as packet loss, power (lower core frequency) and resource utilization (Last Level Cache occupancy).

For example, the reward signal value can be computed using the three key performance indicators discussed above as shown below:

Rₜ₊₁=−Ø_{α}*pktₗₒₛₛ_{_}ᵣₐₜₑ−Ø₁*care_{freq}*−Ø_{z}*cache_occupancy

where Ø₀, Ø₁ and Ø₂ are coefficients that can be fine-tuned.

The process shown in FIG. 6 is repeated during the learning phase until the reinforcement learning algorithm 504 converges to an optimal resource allocation. In an embodiment, the reinforcement learning algorithm 504 is the Deep Queue Network (DQN) algorithm which is used to learn Q-values corresponding to 14 discrete frequencies. The input to the reinforcement learning algorithm 504 is the current core frequency and next 10 seconds predicted ingress traffic rate.

During the training, the reinforcement learning algorithm 504 explores various frequencies at different conditions and this may result in some scheduling packet loss because if the pipeline is congested, the scheduler can drop packets. The scheduling packet loss together with prescribed frequency information are formulated into a scaler reward signal 614 indicating the effectiveness of the previous frequency decision. Through numerous trial and error learning process, the neural network converges to an optimal mapping from any forecasted incoming packet rate to lowest running frequency without scheduling packet loss.

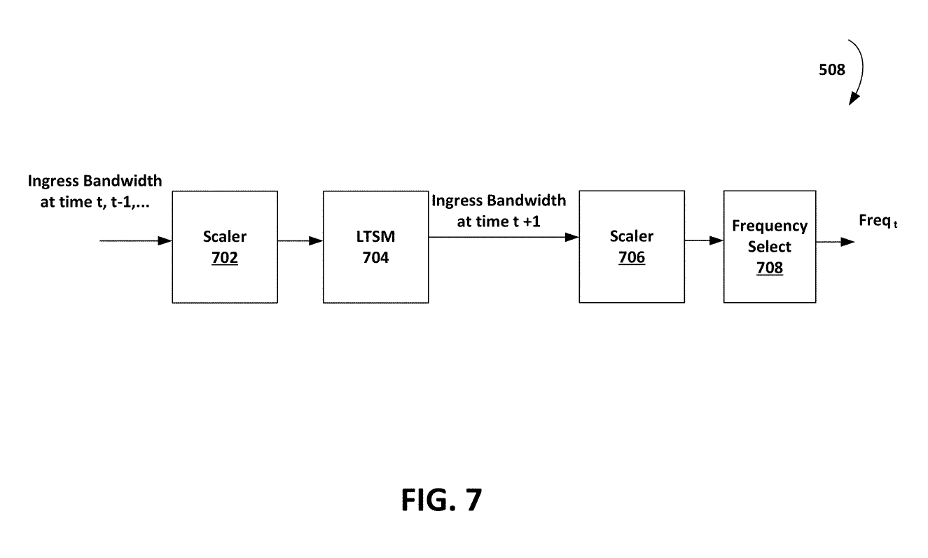

FIG. 7 is a block diagram of the Long Short Term Memory (LSTM) Recurrent Neural Network 508 shown in FIG. 6 to perform ingress traffic bandwidth forecasting. After the LSTM forecasting model 508 has been trained, the LSTM forecasting model 508 is used in the ingress bandwidth prediction pipeline 600 to predict a next 10 second ingress packet rate using a previous 32 seconds packet rate.

A look-up table can be created based on measured frequency of the core clock for different packet rates. Based on the highest packet rate predicted for the next 10 seconds, the look-up table provides an estimate of a core clock frequency that guarantees no packet scheduling loss in the vCMTS process pipeline which can be referred to as threshold based frequency scaling.

Scaler 702 scales input data (previous ingress packet rate) to a normalized value.

LSTM forecasting model 704 predicts ingress packet rates for the next 10 seconds based on the normalized value received from scaler 702.

Scaler 706 scales the next 10 second ingress packet rate received from the LSTM forecasting model 704 to normalized values.

Frequency Select 708 selects the maximum ingress packet rate from the 10 received ingress packet rates for the next 10 seconds.

With accurate workload forecasting, clock frequency for the processor core 102 can be set for power saving with no packet loss. Applying reinforcement learning provides power saving by finding the lowest operating frequency at any given ingress packet rate with no scheduling packet loss.

In an example, system 100 can be implemented using interconnected compute sleds of processors, memories, storages, network interfaces, and other components. High speed interconnects can be used such as PCIe, Ethernet as described in Institute of Electrical and Electronics Engineers (IEEE) 802.3, or optical interconnects (or a combination thereof).

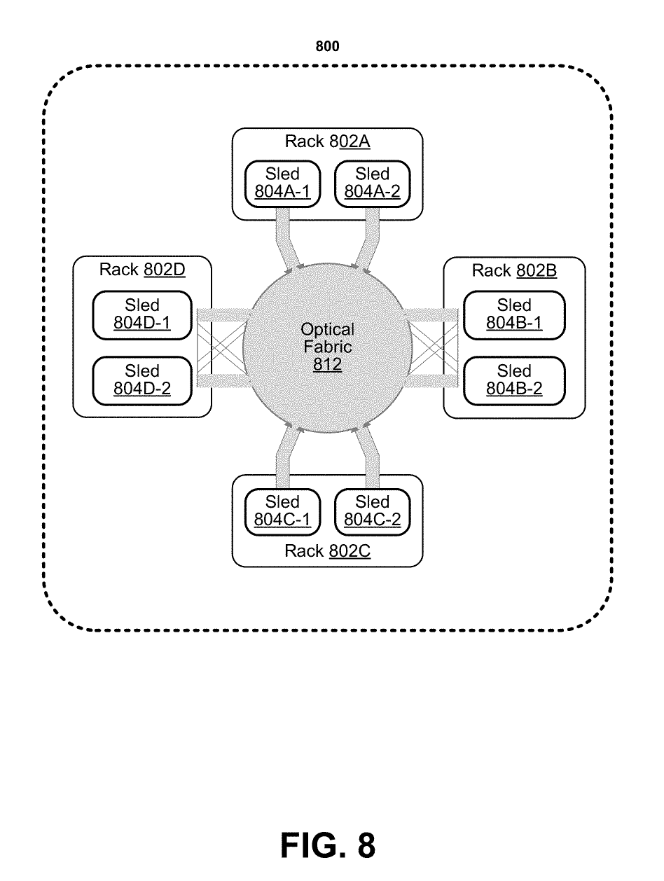

FIG. 8 depicts an example of a data center 800. Various embodiments can be used in or with the data center of FIG. 8. As shown in FIG. 8, data center 800 may include an optical fabric 812. Optical fabric 812 may generally include a combination of optical signaling media (such as optical cabling) and optical switching infrastructure via which any particular sled in data center 800 can send signals to (and receive signals from) the other sleds in data center 800. The signaling connectivity that optical fabric 812 provides to any given sled may include connectivity both to other sleds in a same rack and sleds in other racks. Data center 800 includes four racks 802A to 802D and racks 802A to 802D house respective pairs of sleds 804A-1 and 804A-2, 804B-1 and 804B-2, 804C-1 and 804C-2, and 804D-1 and 804D-2. Thus, in this example, data center 800 includes a total of eight sleds. Optical fabric 8012 can provide sled signaling connectivity with one or more of the seven other sleds. For example, via optical fabric 8012, sled 804A-1 in rack 802A may possess signaling connectivity with sled 804A-2 in rack 802A, as well as the six other sleds 804B-1, 804B-2, 804C-1, 804C-2, 804D-1, and 804D-2 that are distributed among the other racks 802B, 802C, and 802D of data center 800. The embodiments are not limited to this example. For example, fabric 812 can provide optical and/or electrical signaling.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. An apparatus comprising:
a memory to store a plurality of system telemetry data, the plurality of system telemetry data including a subset of system telemetry data representing a performance indicator; and
a machine learning algorithm to be applied to the subset of system telemetry data to predict a future trend for the performance indicator from values of the subset of system telemetry data sampled over a period of time.

2. The apparatus of claim 1, further comprising:
reinforcement learning to take a proactive action to prevent service degradation based on the future trend.

3. The apparatus of claim 2, wherein the performance indicator is packet loss percentage rate and the future trend is packet loss or no packet loss.

4. The apparatus of claim 3, wherein the subset of system telemetry data includes telemetry data that has a close correlation with the packet loss percentage rate.

5. The apparatus of claim 4, wherein the subset of system telemetry data includes telemetry data related to memory usage.

6. The apparatus of claim 2, wherein the performance indicator is workload bandwidth based on an ingress traffic pattern and the future trend is modification of a clock frequency for a core.

7. The apparatus of claim 6, wherein the subset of system telemetry data includes telemetry data that has a close correlation with workload bandwidth.

8. The apparatus of claim 7, wherein the subset of system telemetry data includes data related to Central Processing Unit (CPU) metrics.

9. A method comprising:
storing a plurality of system telemetry data in a memory, the plurality of system telemetry data including a subset of system telemetry data representing a performance indicator; and
applying a machine learning algorithm to the subset of system telemetry data to predict a future trend for the performance indicator from values of the subset of system telemetry data sampled over a period of time.

10. The method of claim 9, further comprising:
taking a proactive action to prevent service degradation based on the future trend.

11. The method of claim 10, wherein the performance indicator is packet loss percentage rate and the future trend is packet loss or no packet loss.

12. The method of claim 11, wherein the subset of system telemetry data includes telemetry data related to memory usage.

13. The method of claim 10, wherein the performance indicator is workload bandwidth based on an ingress traffic pattern and the future trend is modification of a clock frequency for a core.

14. The method of claim 13, wherein the subset of system telemetry data includes telemetry data related to Central Processing Unit (CPU) metrics.

15. A system comprising:
a Central Processing Unit comprising at least one processor core;
a memory module, the memory module comprising at least one volatile memory integrated circuit, the volatile memory integrated circuit to store a plurality of system telemetry data, the plurality of system telemetry data including a subset of system telemetry data related to the processor core, the subset of system telemetry data representing a performance indicator; and
a machine learning classifier to be applied to the subset of system telemetry data to predict a future trend for the performance indicator from values of the subset of system telemetry data sampled over a period of time.

16. The system of claim 15, further comprising:
reinforcement learning to take a proactive action to prevent service degradation based on the future trend.

17. The system of claim 16, wherein the performance indicator is packet loss percentage rate and the future trend is packet loss or no packet loss.

18. The system of claim 17, wherein the subset of system telemetry data includes telemetry data related to memory usage.

19. The system of claim 16, wherein the performance indicator is workload bandwidth based on an ingress traffic pattern and the future trend is modification of a clock frequency for a core.

20. The system of claim 19, wherein the subset of system telemetry data includes telemetry data related to Central Processing Unit (CPU) metrics.
